(19) United States
(12) Patent Application Publication
(10) Pub. No.: US 2016/0196527 A1
(43) Pub. Date: Jul. 7, 2016

(54) CONDITION MONITORING AND PREDICTION FOR SMART LOGISTICS

(71) Applicant: FALKONRY, INC., Santa Clara, CA (US)

(72) Inventors: Prasanta Bose, Sunnyvale, CA (US); Nikunj R. Mehta, Cupertino, CA (US)

(21) Appl. No.: 14/590,756

(22) Filed: Jan. 6, 2015

(51) Int. Cl. G06Q 10/08; G06N 5/04; G06Q 10/06; G06N 99/00; H04W 4/02; H04W 4/04

(52) U.S. Cl. CPC G06Q 10/0832; H04W 4/021; H04W 4/046; G06Q 10/067; G06N 99/005; G06N 5/04

(57) ABSTRACT

Techniques are described for condition monitoring and prediction. According to embodiments described herein one or more computing devices receive a set of sensor data from a set of sensors. The sensor data identifies a condition associated with at least one mobile item moving through a particular geographic region and route that correspond to at least one cell in a transportation network representation. The one or more computing devices determine, from the sensor data, a correlation between the condition associated with the at least one mobile item and a set of one or more other conditions that are associated with the at least one cell in the route. The one or more computing device generate, based, at least in part, on the correlation, a prediction of a quality of service for the particular item that is associated with the route including the particular geographic region and corresponding to at least one cell in the transportation network representation.

### TECHNICAL FIELD

The present disclosure generally relates to techniques in the field of quality-of-service (QoS) prediction and optimization. The disclosure relates more specifically to computer-implemented techniques for predictive estimation of QoS across supply chains using condition monitoring and predictive analytics.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Supply chain logistics involves the administration of systems and processes for the transportation of goods or other items from a source location to a point of consumption. Transportation vehicles and fleets within the supply chain are increasingly challenged to assure quality delivery of goods while reducing costs and meeting regulations. Various factors such as traffic, weather, and vehicle failures may significantly impact and degrade the delivery quality if the transportation fleet is not appropriately equipped to predict, avoid, and/or react to changing and potentially harmful conditions along the supply chain.

Certain supply chains face unique types of constraints that may pose peculiar challenges for delivery and transportation systems. For example, food and other perishable goods often need to be kept cold to prevent spoilage. A trucking company responsible for transporting such perishable goods may be required to ensure or prove that its cargo was kept within a certain temperature range during transit. A damaged refrigeration unit, an open door, or mechanical problems with the vehicle can prove to be catastrophic for a refrigerated shipment. Other types of goods and services may face different or additional constraints and react to varying conditions along the supply chain in unique ways. Due to the large number of possible scenarios, ensuring a certain quality of service can be a difficult and complex task.

### BRIEF DESCRIPTION OF THE DRAWINGS

In the drawings:

FIG. 1 illustrates an example process for predicting a QoS based on condition monitoring.

FIG. 2 illustrates an example arrangement of a quality management system.

FIG. 3 illustrates an example internet-of-things and machine-to-machine equipped cyber physical system.

FIG. 4 illustrates an example transportation network representation comprising a set of network cells.

FIG. 5 illustrates an example histogram of speed in a transportation cell showing bimodal distribution.

FIG. 6 illustrates a graph of a transportation cell grid with dashed lines representing a route.

FIG. 7 illustrates a graphical model to present conditional dependencies between transportation cell variables.

FIG. 8 illustrates a two slices of a dynamic Bayesian network of a transportation cell that represents a snapshot of an evolving temporal process in multi-state transportation cell conditions.

FIG. 9 illustrates an example process overview for tracking and predicting remaining shelf life of a supplied item.

FIG. 10 illustrates an underlying process flows for remaining shelf life analysis and prediction.

FIG. 11 illustrates an example representation of bacterial growth in time that is used for predicting an evaluation of food spoilage.

FIG. 12 is a bar cart illustrating deterioration times for a perishable item stored at varying conditions.

FIG. 13 illustrates a chart projecting remaining shelf life for a perishable item.

FIG. 14 is a chart depicting a multivariate regression approach for data-driven model generation.

FIG. 15 illustrates a representation of a virtual sensor network for performing condition monitoring and prediction.

FIG. 16 illustrates an example system architecture for condition monitoring and prediction.

FIG. 17 illustrates an example data flow and integration endpoints for condition monitoring and prediction.

FIG. 18 illustrates an example computer system that may be configured to implement individually or in cooperation with other computer systems, various technical steps described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

Techniques are described herein for condition monitoring and quality-of-service (QoS) predictions relating to the transportation of the mobile items. A mobile item, as used herein may include, without limitation, packages, perishable goods, non-perishable goods, people, and/or other animate or inanimate entities that may be transported from one physical location to another physical location. A mobile item may refer to an item currently in transit, such as a package that is in the process of shipping, an item that was previously in transit, such as packages that have arrived at a destination, or an item that is planned for transit at a future time, such as items that have not yet shipped or otherwise left a source destination. A mobile item may be self-transporting or may be transported by vehicle, person, or some other entity.

Predicting a QoS associated with the delivery of mobile items is challenged by changes in transportation environment conditions such as temperature, vibration, etc., as well as time taken to deliver the mobile item. In various embodiments described herein, computer systems, stored instructions, and technical steps are described for building probabilistic models from condition-based monitoring of mobile items. The probabilistic models may be used for predictive analytics in a variety of scenarios including, without limitation, predicting an expected time of arrival and duration of travel for mobile items, alerting users of abnormal detected conditions on delay and environment conditions that impact a delivery quality of a mobile item, and predicting remaining shelf life (RSL) of an item based on spoilage indicators and patterns.

Predicting QoS for mobile items may further be challenged by low sampling rates from resource constrained monitoring devices and continuous changes in location-sensitive parameter values. According to some embodiments described herein, an innovative cell-based transportation network model organizes data on both a spatial and temporal scale. The cell-based analytics described herein provide an adjustable level of granularity for identifying covariance patterns relevant to generating probabilistic models and making QoS predictions. The cells further allow for
generalizing to include transportation corridors for integration of uncertain environment conditions such as congestion and other data in QoS processing that enables robust estimation with uncertain and power-constrained sensors;
creating a composable and scalable model for local updating via machine learning techniques and estimating QoS that scales to cover large distances and geographic areas;
creating overlay virtual sensor networks across mobile entities that share the same route for cooperative and adaptive routing in the context of abnormal cell events; and
abstracting measurements over a cell in learning probabilistic model representations that relate expected conditions with causal environment and specific driving factors.

In various examples, a quality management system is deployed to perform real-time tracking and condition monitoring of variable-sized transportation fleets, whose members may span different geo-regions and paths. Within a transportation fleet, each respective vehicle may carry one or more packages and/or other cargo with corresponding reporting sensors. The reporting sensors collect data measuring conditions of the cargo, vehicle, and/or transportation environment. The quality management system receives and processes the collected data to build and refine probabilistic models used to predict QoS parameter values and recommend pertinent actions.

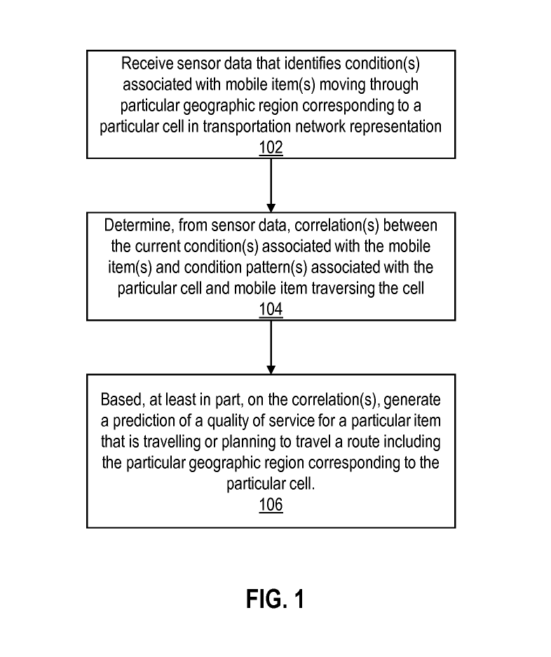

FIG. 1 illustrates an example process for predicting a QoS based on condition monitoring. Step 102 includes receiving, at one or more computing devices over a network from a set of sensors, a set of sensor data that identifies a condition associated with at least one mobile item moving through a particular geographic region corresponding to at least one cell in a transportation network representation. In step 104, the one or more computing devices determine, from the sensor data, a correlation between the condition associated with the at least one mobile item and a set of one or more other conditions that are associated with the at least one cell. In step 106, the one or more computing device generate, based, at least in part, on the correlation, a prediction of a quality of service for a particular item that is travelling, planning to travel, or otherwise associated with a route including the particular geographic region corresponding to the at least one cell in the transportation network.

Predictive Monitoring Framework

According to one embodiment, a quality management system provides a modular, decentralized, and predictive monitoring framework for condition detection and alerting. The framework may be probabilistically programmed using machine learning techniques at run-time to adaptively learn and update QoS prediction models. The predictive monitoring framework provides a dynamic solution that reacts to changing conditions in mobile items and the environment surrounding the mobile items. Static rule-based or case-based systems are difficult to manually program and maintain. Further, rule-based systems typically cannot cover all possible scenarios or properly handle uncertainty in sensor data. By contrast, the predictive monitoring framework entails a stochastic/statistics based machine learning approach that does not require all possible scenarios to be hard-coded in before run time and can account for inexact approximations in the sensor data.

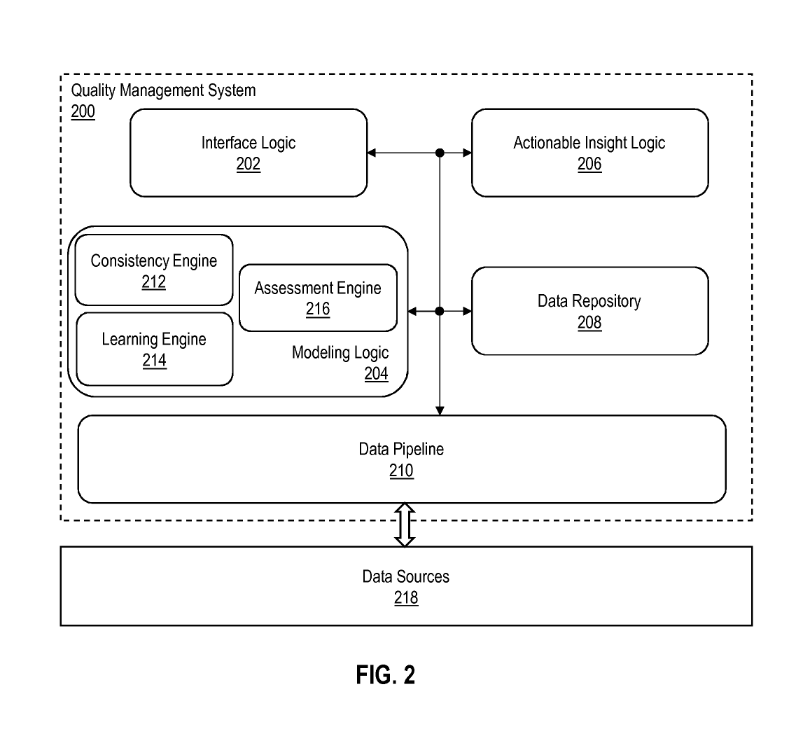

FIG. 2 illustrates an example arrangement of a quality management system, according to one embodiment. Quality management system 200 generally comprises interface logic 202, modeling logic 204, actionable insight logic 206, data repositories 208, and data pipeline 210. As used herein, “logic” may refer to the instructions, software modules, processes, hardware, and/or other computing resources used to carry out a particular set of one or more functions. The logic of quality management system 200 may be centralized on one computing device, a cluster of computing devices, or a single cloud, or may be distributed over multiple computing devices, multiple clusters, and/or multiple clouds

Data sources 218 stream or otherwise send data to data pipeline 210. Data sources 218 may include, without limitation, current sensor observations, historical sensor observations, and maintenance reports relating to observations not captured by sensors. Current sensor observations include sensor data that is streamed from sensors in real-time or with slight buffer delays as the data is collected. Historical sensor observations include sensor observations that were captured as part of a past collection event. Maintenance reports include data that may be used for probabilistic modeling and is not captured by sensors. For example, maintenance reports may include human-observed characteristics that have been manually added to a computing system.

Interface logic 202 supports one or more user interfaces for interacting with quality management system 200. The user interface may comprise, without limitation, a graphical user interface (GUI), an application programming interface (API), a command-line interface (CLI) or some other means of interacting with a user. A “user” in this context may include, without limitation, an application or a human user such as a system administrator. A user may interact with quality management system 200 to perform tasks such as configuring system parameters, submitting service requests related to QoS predictions, and viewing QoS predictions or other output data generated by quality management system 200.

Modeling logic 204 builds quality of service models for probabilistically predicting a QoS for a mobile item. Modeling logic 204 generally comprises consistency engine 212, learning engine 214, and assessment engine 216. Learning engine 214 uses machine learning techniques to construct and adapt the probabilistic models based on the collected data. If consistency engine 212 determines that the current state of a mobile item is not consistent with a corresponding probabilistic model, then learning engine 214 updates the probabilistic model using observed parameters that led to the current state of the mobile item. Learning engine 214 identifies and learns correlations within the data, such as covariance patterns, to build and update the probabilistic models. Assessment engine 216 performs assessments based on the probabilistic models and current state of a set of one or more mobile items. As an example, assessment engine may generate a QoS prediction for the mobile item given the current state of the mobile item. Consistency engine 212 fuses assessments generated by assessment engine 216 to improve the accuracy of the assessment.

Actionable insight logic 206 generates recommendations and/or performs actions based on fused assessments generated by consistency engine 212. The recommendations and actions may help improve a QoS related to delivery of a mobile item. For example, actionable insight logic 206 may recommend re-routing shipment of the mobile item to improve an estimated time of arrival for the mobile item. As another example, actionable insight logic 206 may perform a corrective action to prevent or mitigate conditions that increase the rate of spoilage of a mobile item. Other example recommendations and actions are described further below. Actionable insight logic 206 may coordinate recommendations across multiple actors, such as a fleet of vehicles.

Data repository 208 includes one or more databases or other repositories that are part of a persistence layer for quality management system 200. Data repository 208 persistently stores a variety of data, which may include, without limitation, data collected from data sources 218, probabilistic models generated by modeling logic 204, and/or recommendation data generated by actionable insight logic 206. Data repository 208 may include a time-series store that correlates observed data with specific points in time. In addition or alternatively, data repository 208 may include an anomaly and conditions repository that store anomalous conditions for a particular route.

Cyber-Physical Transportation Systems

The techniques described herein are implemented using a cyber-physical system oriented ontology and supporting data models, according to one embodiment. In the context of a vehicle that is transporting cargo to a destination location, the cyber-physical system oriented ontology and data model may treat the cargo and the transportation vehicle as a single mobile system or entity. In a multi-actor system, quality management system 200 may monitor and track a plurality of mobile systems or entities, with each mobile system or entity corresponding to a different vehicle or cargo.

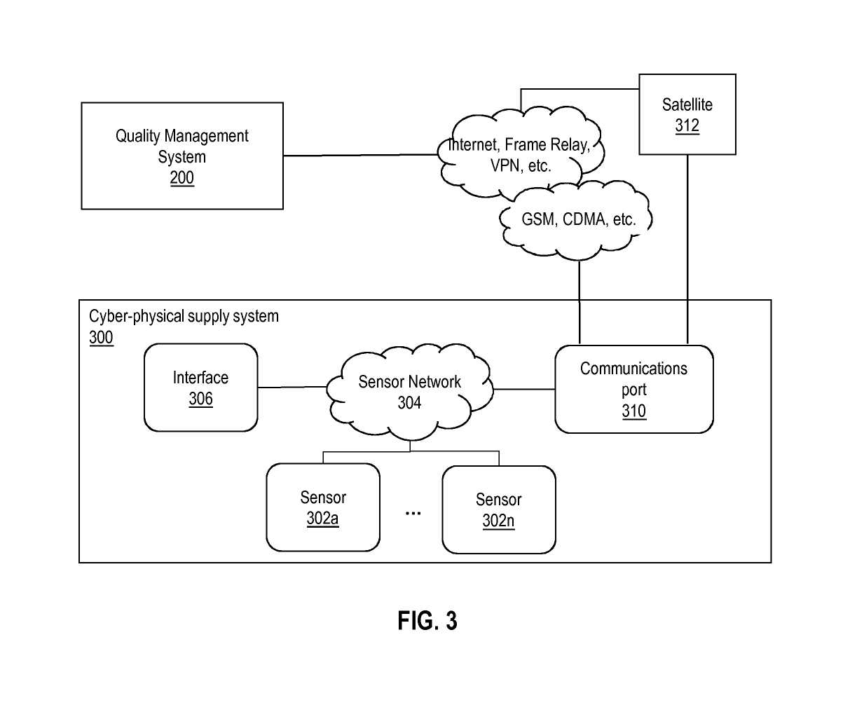

FIG. 3 illustrates an example internet-of-things (IoT) and machine-to-machine equipped cyber-physical system. Cyber-physical system 300 generally includes sensors 302a to 302n, sensor network 304, interface 306, and communications port 310. In one embodiment, cyber-physical system 300 is a supply vehicle or some other mobile entity involved in transporting cargo.

Sensors 302a to 302n include one or more sensors that monitor conditions associated with cyber-physical system 300. Sensors 302a to 302n may include sensors that monitor individual cargo units and sensors that monitor the transportation environment within cyber-physical system 300. Example sensors may include, without limitation, door latch sensors, tire pressure sensors, oxygen-level sensors, stress sensors, chemical sensors, reefer sensors for refrigerated trailers, and/or temperatures sensors. Sensors 302a to 302n may be distributed across a plurality of locations within cyber-physical system 300, including, without limitation, within vehicular components, inside a box or pallet containing a cargo unit, and/or buried within a product itself. In some cases, sensors 302a to 302n may be self-powered devices.

Sensors 302a to 302n generate sensor data based on monitored conditions and transmit the sensor data via sensor network 304 and communications port 310. In the context of a physical supply network, sensor network 304 may comprise a wireless vehicle area network (VAN) and/or a vehicle bus interface. Thus, sensors within a vehicle may be directly connected or may communicate wirelessly.

Interface 306 allows a user of cyber-physical system 300 to interact with sensors 302a to 302n. In the context of a cyber-physical supply vehicle, for instance, interface 306 may comprise an in-cab display that presents sensor data to a driver. In addition or as an alternative to displaying sensor data, interface 306 may display QoS predictions and/or recommended actions that are received from quality management system 200. For example, interface 306 may display an estimated time of arrival (ETA), recommend routes for delivering mobile items.

Communications port 310 acts as a gateway for communicating with quality management system 200. For example, communication port 310 may include, without limitation, a cellular gateway and/or a global positioning system (GPS) gateway. As a cellular gateway, communications port 310 transmits sensor data via cell sites or cell towers according to mobile communication standards, such as code division multiple access (CDMA), global system for mobile communications (GSM), etc. As a GPS gateway, communications port 310 transmits sensor data via a satellite. Although only one communications port is depicted, other communication ports may also be used to transmit sensor data, depending on the particular implementation.

Cell-Based Representation Of Transportation Networks

Geolocation information is useful in tracking and predicting QoS values for mobile items. In one embodiment, quality management system 200 maintains a cell-based representation of a transportation network to capture geolocation information. A “transportation network representation” as used herein refers to a set of geolocation data representing a geographic area through which mobile items are transported. A transportation network representation comprises a set of transportation cells, where each “cell” represents a particular bounded region within the geographic area.

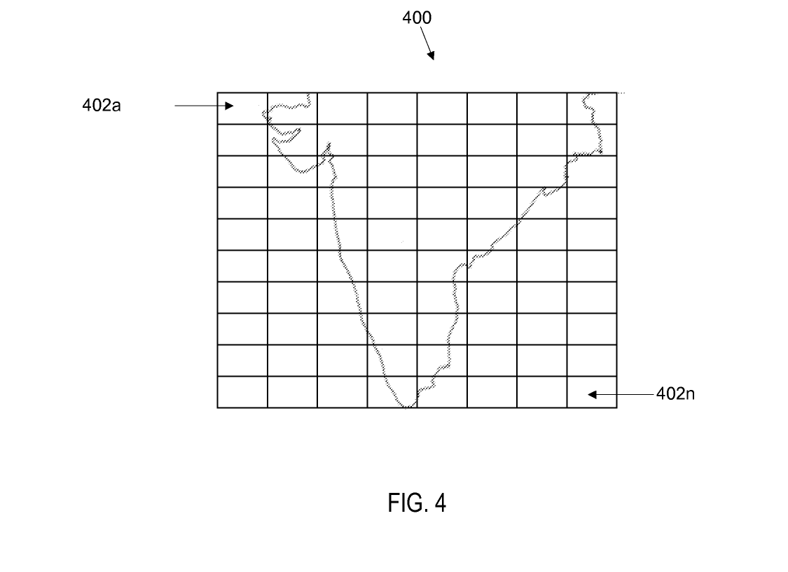

FIG. 4 illustrates an example transportation network representation comprising a set of network cells. Transportation network representation 400 comprises mapping data for a particular geographic region that is divided across a grid of cells, including cells 402a and 402n. Each cell corresponds to a different bounded geographic region within the geographic area covered by transportation network representation 400. Although the cells depicted in transportation network representation 400 are rectangular in shape, other shapes may also be used. Examples include, without limitation, octagonal and hexagonal shapes. Furthermore, the size and density of the cells may vary as described further below.

Each cell within transportation network representation 400 captures statistical information about the corresponding geographical region covered by the cell. As an example, a cell may capture traffic and driving attributes in the corresponding geographical region, such as statistical information about speed limit within the cell or how long it takes a mobile item to pass through a cell. As another example, the cell may capture statistical information about the temperature of refrigerated goods that pass through the corresponding geographical region.

In an embodiment, the statistical information for a cell correlates conditions within the cell to one or more conditions associated with mobile item passing through a cell. For example, the cell may correlate traffic observations, weather conditions, and/or other cell-specific characteristics with an average duration of time it takes to travel through the cell or an average spoilage rate for mobile items under such cell conditions.

In one embodiment, the statistical information for a cell is generated based on sensor data collected from sensors equipped on mobile cyber-physical systems that have passed through the corresponding geographical region. For example, sensors 302a to 302n may transmit the sensor data to quality management system 200 continuously or at various waypoints. Upon receipt of such data, modeling logic 202 may correlate the sensor data with a particular cell corresponding to the geographic region where the sensor data was generated and/or collected.

In another embodiment, the statistical information may be determined based on external sources of information. For example, weather observations and traffic patterns for a particular cell may be extracted from one or more external web service platforms. Modeling logic 204 may combine this external data with collected sensor data or may use the external data independently to derive statistical information for a cell.

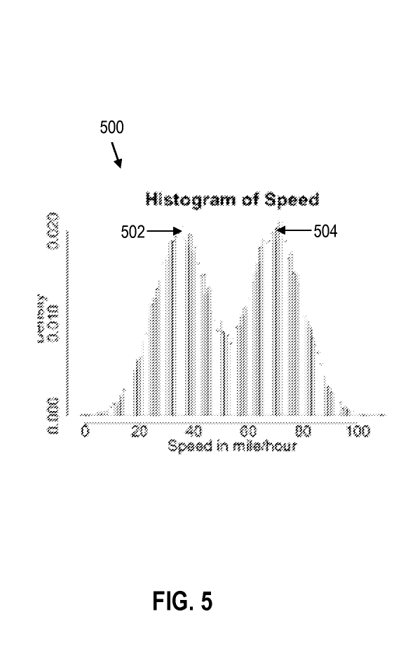

The statistical information captured by a particular cell may be associated with different modes. The different modes identify values within a particular cell that are most common within the cell. Referring to FIG. 5, it illustrates histogram 500 representing the speed in a transportation cell showing bimodal distribution. As can be observed from histogram 500, there are two main speed behaviors in the region represented by the transportation cell: one with average of thirty-five miles per hour (mph) and one with average of sixty mph. Thus, travel through this area has two main modes, as indicated by point 502 and point 504.

The grid also identifies whether there are connections between cells in the grid. If at least one direct viable path exists between any point inside one cell to some point in the other cell, then a grid connection between those two cells is maintained. A mathematical abstraction of the transportation grid with the cells and their interconnection is a sparse graph as follows. Let G(V,E) be a graph with nodes V and edges E that presents a transportation grid. Each node v∈V represents a cell in the transportation grid. There is an edge e∈E that connects node v_1∈V to node v_2∈V if and only if there exist a connection between cell v_1 to cell v_2 in the transportation system.

Multi-Scale Cell-Based Overlay

The cell size within a transportation network representation may vary from implementation to implementation and between different geographic areas within the same transportation grid. For example, a first cell size may be used to capture sensor data and perform correlation for a first city, and a different cell size may be used for a second city.

In one embodiment, the cells within the transportation network representation are variable in size. As an example, each cell within a particular region may initially cover an area of 20 by 20 square miles (mi²) or some other area of arbitrary size. The cell size of the region may then be increased or decreased to adjust the manner in which data is captured and correlated for the geographic region. For instance, cell may be divided into multiple smaller cells, merged with one or more other cells to form a larger cell, or otherwise resized to cover a greater or lesser geographic area.

Broader cells may overlap with multiple smaller cells within the transportation network representation. For example, a 20 by 20 mi² cell may overlap with four 10 by 10 mi² cells. Each of the smaller cells may further overlap other smaller cells. The size of the cells may be adapted to conditions within the geographic region. This allows correlations to be made at different granularity of cell sizes.

Cell granularity affects ability to correlate and form accurate predictions. If the cell is too fine grained, there may not be enough sampled data to form meaningful correlations. If the cell is too coarse, then the predictive models may not be fine-tuned enough to make accurate predictions. The size and density of the cells may be selected based on a sampling rate of data for the geographic area covered by the cells to optimize correlation and prediction accuracy. Generally, the lower the sampling rate, the higher the cell sizes that are used. Conversely, the cell sizes may be reduced as the sampling rate increases. In an embodiment, cells are sized so that the density of cells reflects the density of a transportation area but no smaller than what can be covered between two consecutive tracking messages. A “tracking message” in this context refers to a message sent by a cyber-physical system that is used to transmit tracking/sensor data for a mobile item.

Various conditions may affect the sampling rate within a cell. For example, traffic patterns, the location of cell towers, power constraints of the sensor devices, and/or weather conditions may affect the sampling of data from one or more cells in a particular geographic region. The cell sizes may be progressively refined over time to adapt to the changing conditions. As the sampling rate for a region increases or decreases over time, the cell sizes corresponding to the region may be adaptively increased or decreased. In other embodiments, the cell size may be predetermined and statically set during system runtime.

Cell-Based Representation of Routes

A shipment or delivery of a mobile item may be defined as a route from a specific source location to a specific destination location. In the context of a transportation network representation, a shipment starts from one cell, referred to herein as a “source cell”, and ends in another cell, referred to as a “destination cell”. The shipment may be modeled as a path in a cell graph, traversing a plurality of cells including the source node and the destination node.

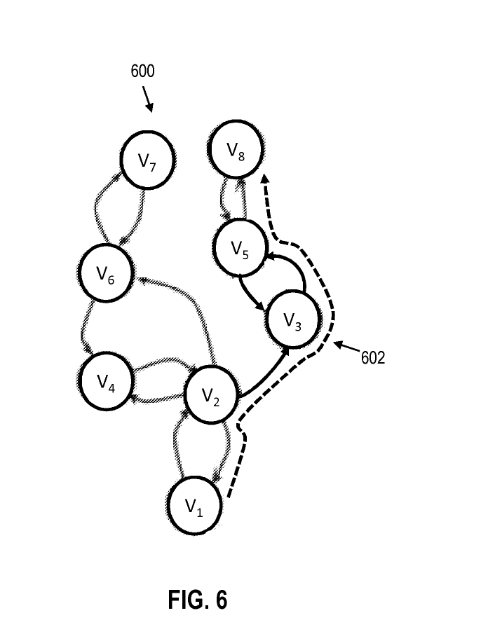

FIG. 6 illustrates a graph of a transportation cell grid with dashed lines representing a route. Transportation cell grid 600 includes cells v₁-v₈. The arrows between the cells represent connections between cells in the transportation cell grid. Path 602 indicates an example route within transportation cell grid, where cell v1 is the source cell and cell vs is the destination cell. The route corresponding to path 602 may be represented as a series of cells from the source cell to the destination cell as follows: v₁ v₂ v₃ v₅ v₈.

For a given cell-based representation of a route, assessment engine 216 may generate predictions about the QoS of a mobile item. Assessment engine 216 applies the probabilistic models, as described further herein, based, at least in part, on the state of the cells within a route. For example, certain condition variables within cells v₁, v₂, v₃, v₅, and v₈ may affect various QoS parameters for mobile items traversing path 602. Assessment engine 216 may analyze conditions such as traffic patterns, weather, temperature or other variables within each of the cells within a route. In view of such conditions, assessment engine 216 may apply learned probabilistic models to estimate the probability of various conditions related to the delivery of a mobile item once the mobile item arrives at the destination cell vs.

Latency, Incomplete and Noisy Sensor Data-Tolerant Approximation Analytics

One challenge in estimating and tracking QoS parameters for mobile items is that sensors may be under power resource constraints or unable to communicate in certain regions due to low coverage range. For a self-powered IoT device, a high frequency of data transmission may cause the power to run out before the mobile item is delivered. Further, the IoT device may not be able to transmit data in certain regions where the device does not have access to cell towers and/or GPS services.

In one embodiment, quality management system 200 manages the global notion of time to accommodate for latency in the receipt of data and to synchronize data across the system. When sensor data is received, quality management system 200 determines the timeframe and the cell from which the data was collected. The determination may be made based on timestamp information, geo-tags, and/or other metadata associated with the sensor data. Quality management system 200 takes such information into account when updating the probabilistic models.

As an example, a plurality of cyber-physical systems may be transmitting data to quality management system 200. In the timeframe T1-T5, where T1-T5 represent different windows or “slices” of time, a particular cyber-physical system may be unable to transmit data to quality management system 200 due to a communication dead zone, power constraints, or some other reason. In such a scenario, the cyber-physical system may buffer data generated by on-board sensors. At time T6, the cyber-physical system may transmit a batch of data to quality management system 200. The data may include, without limitation, locations, times, and sensor measurements from time slices T1-T6. In response to receipt of the data, quality management system 200 may analyze the data to determine the current conditions of the cyber-physical system at time T6 and the historical conditions from times T1 to T5 that led to the current conditions. Based on the analysis, quality management system 200 may update the probabilistic models.

When updating the models, quality management system 200 performs correlations on a per-cell basis, according to an embodiment. For example, statistical information about traffic, weather, and other conditions may be captured for each cell. A cell may thus provide a generalized and localized representation of statistical information related to traveling through a bounded geographic area. Such generalization allows for uncertainty and incompleteness tolerant approximation analytics, which enables more robust estimating and tracking with uncertain geo-location samples.

As previously mentioned, the cells provide an adjustable level of granularity when identifying covariance patterns. The cells may be adjusted to adapt to conditions where there are low sampling rates. For example, the cell size may be increased as the sampling rate is decreased. In contrast to Hidden Markov Models (HMMs) and other approaches that depend on high sampling rates of information, the cell-based approach may thus be fine-tuned for environments where there is a low or uncertain sampling rate.

QOS Modelling and Prediction

In one embodiment, modeling logic 204 generates QoS prediction models based on data received from data sources 218. The QoS models that are generated may vary from implementation to implementation. Examples may include, without limitation:
Estimated time of arrival (ETA) models. For a given route, these models estimate a time of arrival for a mobile item.
Remaining useful life (RUL)/Remaining shelf life (RSL) models. These models estimate the remaining useful life or remaining shelf life of a mobile item. For perishable items, these models may estimate the trajectory of spoilage to predict when the item is likely to spoil.
Emissions models. These models estimate the emissions involved in transporting a mobile item. For example, the model may predict gas emissions or consumption for a vehicle that is transporting a particular item.

Modeling logic 204 learns from sensor data and/or other data received from data sources 218 to build and update probabilistic models. Modeling logic 204 analyzes the data to identify covariance patterns and other correlations. Based on such correlations, modeling logic 204 builds and updates the probabilistic models. The models are more robust than rule-based methods in that they may identify patterns that are evolving and/or hard to foresee when hard- coding a rules-based system. For example, models may incorporate idiosyncratic and unknown behaviors such as where a particular vehicle is most likely to pause for a rest.

In one embodiment, modeling logic 204 builds and updates Bayesian networks based on data received from data sources 218. The Bayesian network represents probabilistic relationships between conditions within a cell and a QoS associated with travelling through a cell. As an example, the Bayesian network may be used to estimate how long it will take a mobile item to traverse a cell. As another example, the Bayesian network may be used to estimate the effect traversing the cell will have on a mobile item. In the context of perishable items, for instance, the model may estimate the impact on spoilage of the item. In the context of a human traversing a cell, the model may estimate the effect traversing the cell will have on the stress level of the person given the current state of the cell.

Specific examples are provided below for generating probabilistic models for the example predictive models listed above. However, the techniques described may be applied across a variety of different QoS models. For example, the modeling techniques may be used to predict the stress levels for people traversing a particular route or other characteristics of mobile items that traverse a plurality of cells in a transportation network representation.

Environment Condition-Dependant Travel And Quality Predictions

In one embodiment, a cell provides a localized representation of the statistical information about the driving and traffic in a geographic area. This information depends on variables in the cell such as weather condition, time of the day, season, congestion occurrence, etc. These variables and other similar variables define the cell condition. Certain cell characteristics, such as average speed and traffic behavior within the cell, depend on these condition variables. An arc within a probabilistic model may be used to represent such dependencies.

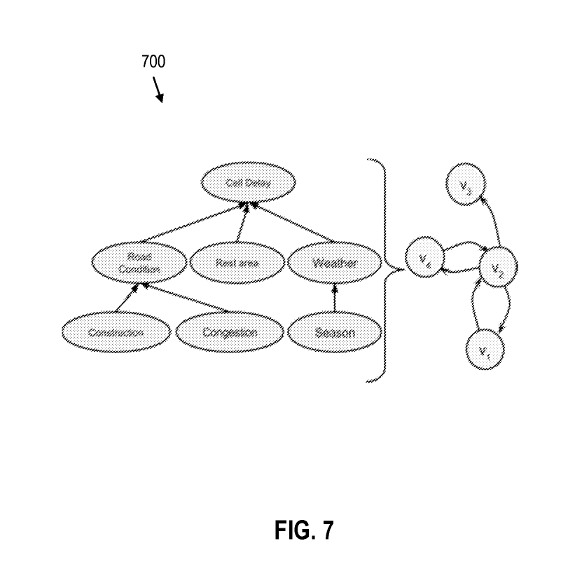

In one embodiment a cell encapsulates a Bayesian model that connects cell attribute to a cell environment condition that affect mobile items within the cell. FIG. 7 illustrates a graphical model to present the conditional dependencies between some cell variables. The objective of graphical model 700 is to find the probability density function (PDF) of the cell delay. “Cell delay” in this context is defined as an amount of time a vehicle spends in the cell before leaving to another cell.

The cell delay depends a variety of cell environment conditions including weather, road conditions, and rest areas within the cell. For example, on raining days the delay PDF changes. Cells with popular rest areas may further affect the PDF of a cell. These condition variables are correlated with cell delay, which may be observed and measured using sensors equipped on vehicles that traverse the cell.

Each of the cell environment conditions may further depend on one or more additional conditions. As an example, the predicted weather for a cell may be dependent on the current season. Thus, the predicted weather and cell delay PDF may change depending on the time of year a mobile item is traversing the cell. As another example, the road condition within the cell may be dependent upon construction and congestion within the cell.

Quality management system 200 learns a Bayesian network model to represent the cause-effect relationship and uses it to form a quantitative model PDF of the delay, speed and traffic in the cell that are dependent on such contextual factors. Given the current weather, road conditions, and rest stops within a cell, the Bayesian network model predicts how long it will take before the mobile item leaves the geographic area covered by the cell. For a given route, the estimates may be combined to generate an ETA prediction.

Dynamic Bayesian Network for Improved Accuracy

Cell event conditions are not detected based on a particular point in time, but can be described through multiple states of observations that yield a judgment of one complete final event. The Bayesian network described in FIG. 7 does not provide a direct mechanism for representing temporal dependencies across cells. However, the state of a cell at one point in time may be indicative of a future state of the cell. For example, the current state of traffic within a cell within a first time slice is likely to affect the state of traffic at an adjacent time slice.

In one embodiment, the quality management system adds a temporal dimension into a Bayes network model by incorporating a Dynamic Belief Network (DBN). The DBN describes a system that is dynamically changing or evolving over time. The DBN formulation learns and updates the system model as time proceeds. The DBN predicts future behavior of the system based on observed historical data.

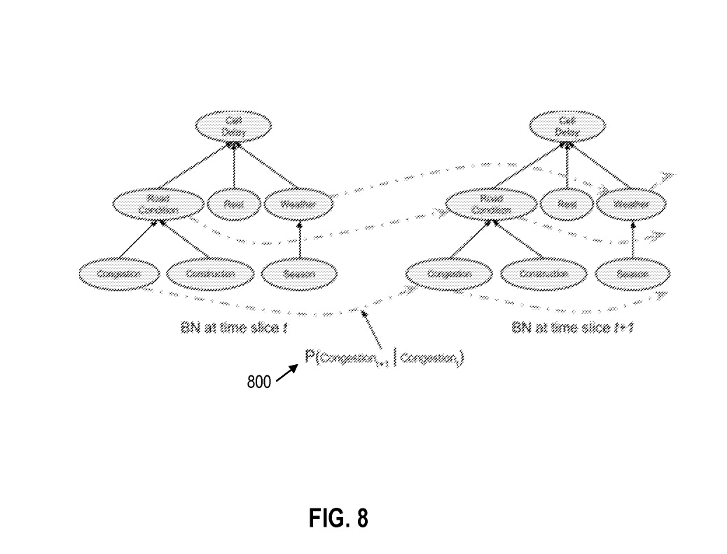

FIG. 8 illustrates a two slices of a dynamic Bayesian network of a transportation cell that represents a snapshot of an evolving temporal process in multi-state transportation cell conditions. The delay PDF 800 is computed based on temporal dependencies across time slices as well as conditional dependencies within the time slice. In an embodiment, the states of the cell environment condition satisfies the Markovian property defined as follows: The state of the cell at time t+1 depends only on its immediate past, i.e., its state at time t. With this DBN formulation, connections are formed both within time slices (referred to herein as “intra-slice connections”) as well as between time slices (referred to herein as “inter-slice connections”). The intra-slice connection creates a belief network that models the cause-effect relation between the condition variables. The inter-slice connection creates temporal dependencies between a subset of variables. As an example, the road condition at time t may depend on 1) the construction and congestion at time t and 2) the road condition observation at time t−1.

In addition or as an alternative to capturing inter-slice connections, a DBN may be used to capture dependencies between different cells within a transportation network representation. For example, the conditions in one cell may affect the conditions in an adjacent or non-adjacent cell. In one embodiment, connections are formed within a cell (referred to herein as “intra-cell connections”) and between different cells (referred to herein as “inter-cell connections”). As an example, the road condition for one cell may affect the congestion at a different connected cell within a transportation grid.

Expected Time of Arrival Prediction

Modeling logic 204 uses the Bayesian networks described above to generate ETA predictions for mobile items, according to one embodiment. As an example, consider a shipment that starts from source vₛₜₐᵣₜ ends in v_{end}. In its trip from vₛₜₐᵣₜ to v_{end}, the shipment travels over multiple cells. Let vₜ be the cell location at time t. For a shipment that is in cell vₜ, it can go to any of its eight neighbors or stay in its current cell position at the next time instance. The selection of the next cell depends on the current cell and the condition of all the cells around the current cell. The following conditional probability denotes the probability of changing cell from vₜ at time t to vₜ₊₁at time t+1:

P(vₜ₊₁|vₜ, θₜ₊₁), P(θₜ₊₁|θₜ) Eq. 1

Eq. 1 shows that the cell location at time t+1 depends on the cell location at time t and cell environment condition at time t+1. A route is defined as a set of consecutive cells that the shipment passes to reach the target cell. In other words, a route is defined as vₛₜₐᵣₜ→v₁→v₂→ . . . →v_{L}→v_{end}. Here L defines the length of the route. Eq. 1 states a parameterized Markovian property in route selection process. One can use this property to predict the next cell and estimate given the current cell of the shipment. Moreover, the cell environment condition at time t+1 depends on the cell environment condition at time t. As mentioned before the cell environment condition is a multidimensional state variable that defines the traffic and driving condition in the cell area. An example of the condition state variable is cell delay and cell congestion.

The expected arrival time, is defined as the statistical average time needed for the shipment to reach its target cell; i.e. v_{end}. Assume at time t the shipment is at cell vₜ. Using the Markovian property, one can predict the possible routes from vₜ to v_{end}. In such a scenario, there are multiple routes from vₜ to v_{end}. Let Γ (vₜ→v_{end}) denote the collection of all possible routes. Then the ETA is defined as:

$$min ETA = {min}_{γ ∈ {Γ}_{t}} {\sum }_{{v}_{i} ∈ γ} \\ {D}_{m i n} [ {v}_{i} ] , ETA = \frac{1}{\vert {Γ}_{t} \vert} {\sum }_{γ ∈ {Γ}_{t}} \\ {\sum }_{{v}_{i} ∈ γ} D [ {v}_{i} ] , max ETA = {min}_{γ ∈ {Γ}_{t} } {\sum }_{{v}_{i} ∈ γ} {D}_{m i n} [ {v}_{i} ] \qquad Eq . 2$$

where Dₘᵢₙ, Dₘₐₓ, and D are the shortest, expected and the longest delay in cell vᵢ.

Remaining Shelf Life Estimation

In one embodiment modeling logic 204 learns and adapts deterioration models based on observed deterioration patterns. For perishable goods, for example, modeling logic may determine which environmental cell and vehicle conditions correlate with increases or decreases in the rate at which spoilage occurs. Modeling logic 204 uses the models to estimate the RUL or RSL of mobile items.

In one embodiment, modeling logic 204 uses particle filters (PFs) and Sequential Monte Carlo to track the spoilage state of mobile items and to generate RSL predictions. The approach may further involve a) exploiting bio-chemical models of spoilage that measures spoilage in terms of bacteria growth b) modeling the physics of bacteria growth in terms of temperature and oxygen parameters, and/or c) exploiting chemical gas measurements for bacteria growth indicators.

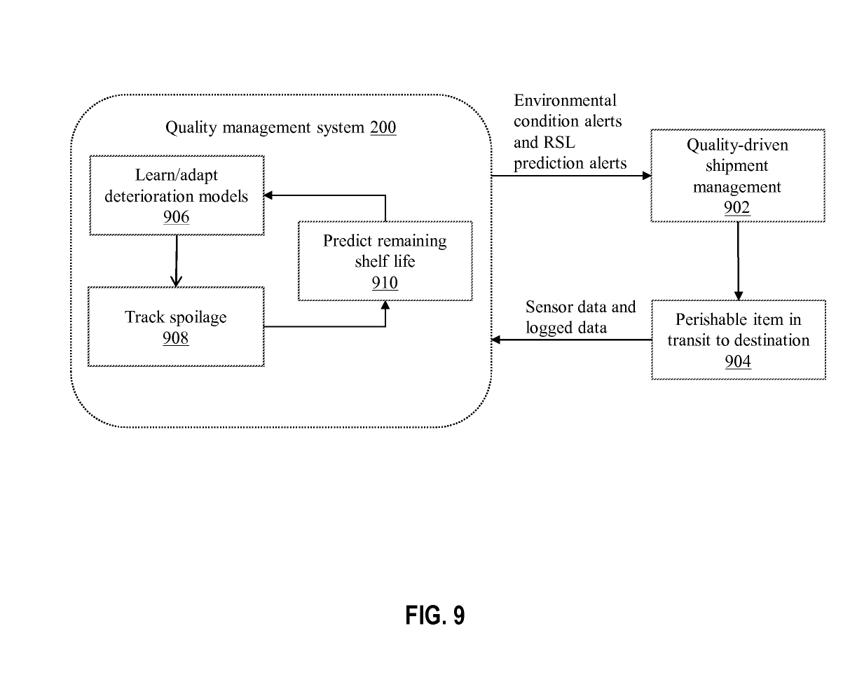

FIG. 9 illustrates an example closed-loop process overview for tracking and predicting remaining shelf life of a supplied item. At block 902, quality-driven shipment management decisions are made. Decisions may include, without limitation, selecting a route for shipping a mobile item, setting a shipping temperature, and/or establishing other shipping parameters for the mobile item.

At block 904, the perishable item moves en route to a destination. While the perishable item is en route, sensor data and/or logged, historical data are sent to quality management system 200. The sensor data may include, without limitation, temperature data the indicates a temperature level within the shipping vehicle and/or shipping container, oxygen levels within the vehicle and/or shipping container, and/or cell conditions that affect the spoilage rate of a perishable item.

At block 906, quality management system 200 learns and adapts deterioration models based on the data provided by block 904. Quality management system 200 may perform feature extraction and regression analysis to compute the models, as described in further detail below.

At block 908, quality management system 200 tracks or estimates the current state of spoilage based on the received data. For example, sensors may track current spoilage levels for a perishable item, or the current spoilage may be computed as a function of spoilage indicators within the transportation environment.

At block 910, the RSL for the mobile item is predicted based on the models computed at block 906 and the current state of spoilage determined at block 910. The RSL may be used as feedback to further learn and adapt the deterioration models at block 906. Quality management system 200 may generate and send alerts to block 902 to notify a user regarding environmental conditions and RSL prediction for mobile items that are in transit. Based on these alerts, quality- driven shipment decisions may be made or adapted. For example, a different route may be chosen, or the temperature within a vehicle may be adjusted to reduce the predicted spoilage of a mobile item.

In an embodiment, modeling logic 204 develops a hybrid approach to RSL tracking and prediction that exploits both statistical and stochastic modeling to track spoilage behavior and predict the RSL. The hybrid approach allows for a higher accuracy in terms of prediction and lower sensitivity to noise. RSL may be analyzed and predicted at a shipment unit level of delivered perishable food that is instrumented with radio-frequency identification (RFID) based sensors.

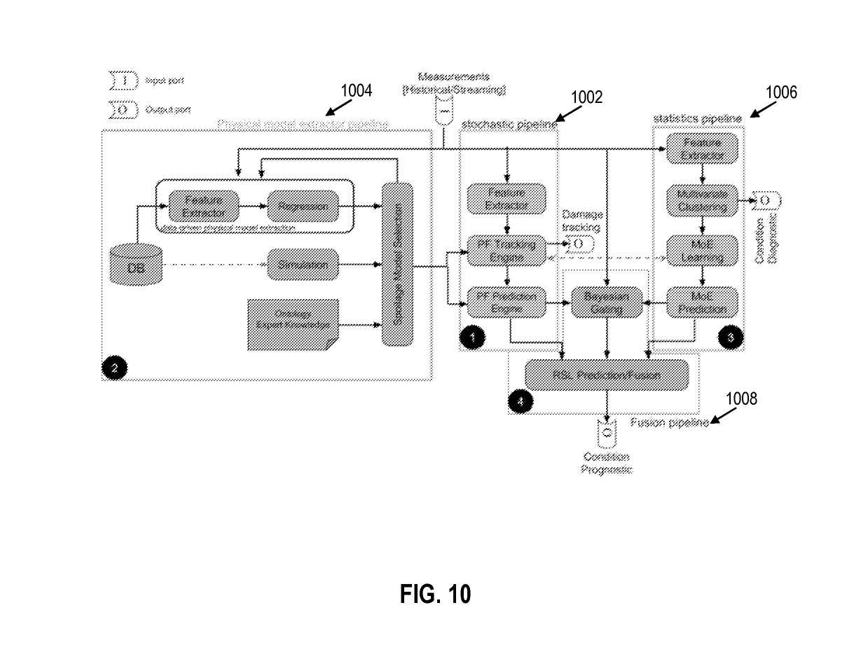

FIG. 10 illustrates the underlying process flow for RSL analysis and prediction. The process flow includes stochastic pipeline 1002, physical model extractor pipeline 1004, statistics pipeline 1006, and fusion pipeline 1008. Each of these pipelines performs a set of steps or functions involved in RSL analysis and prediction for mobile items.

Stochastic pipeline 1002 tracks the spoilage state as a stochastic process. Within stochastic pipeline 1002, feature extraction is performed on sensor and other input data to transform the data into a set of features. Particle Filtering and Sequential Monte Carlo is performed on the feature set to track the spoilage stage in food to the remaining shelf life of food. In the context of perishable items, the spoilage stage may be defined as the bacterial level and its evolution or growth. In some cases, the spoilage stage is not measured directly. In such cases, a hidden or unobservable variable technique is used to construct physical models through which a PF prediction engine may estimate the spoilage stage. Unobservable spoilage stage variables or surrogates thereof are then linked to system observations, such as surface temperature, etc., through system physical models that are constructed by physical model extractor pipeline 1004.

Physical model extractor pipeline 1004 constructs and updates spoilage models based on the streaming and historical input data. Physical model extractor pipeline 1004 provides the spoilage models to other pipelines including stochastic pipeline 1002 and statistics pipeline 1006. As an example, a chemical deterioration model may be a spoilage evolution model that estimates the microbial growth rate over time. The spoilage models may be constructed or updated based on regression analysis of extracted features, simulation, and/or ontology expert knowledge. For instance, the chemical deterioration model previously mentioned may be made available through external ontological knowledge that is input by a user. The model construction and learning process makes minimalist assumptions on the availability of such detailed quantified models. In the absence of detailed models, this pipeline exploits a data-driven approach and the existence of identified parameters to estimate the spoilage and food deterioration model. Modeling logic 204 may exploit historical data used in condition detection and diagnosis to learn such models.

Statistics pipeline 1006 tracks the statistical behavior of ambient conditions that affect the RSL of mobile items. Within this pipeline, multivariate clustering is performed. Multivariate optical elements (MoEs) may be learned and predicted based on the multivariate clustering. This pipeline allows detection of quality deterioration of mobile items. Statistics pipeline 1006 may generate an alert when a) the edibility or other quality of a perishable item reduces significantly and drops below a threshold and/or b) the ambient condition deviates from a desired band or threshold. For example, an alert may be generated if the desired temperature goes above a threshold. Statistics pipeline 1006 may detect abnormal ambient conditions, estimate the trajectory of spoilage if the conditions remain unchanged in the future, and predict a time at which the food or other perishable item crosses a freshness/edible quality threshold under the current conditions.

Fusion pipeline 1008 generates RSL predictions for mobile items. Fusion pipeline 1008 uses Bayesian gating to create belief networks that track and predict the remaining shelf life of the food given the ambient condition and transportation time and environment. The prediction takes into account the environment condition, transportation system and time, and type of spoilage that is evolving. For example, the prediction may take into account bacterial growth or yeast evolution when generating the RSL prediction.

Pre-Processing and Feature Extraction

When updating and constructing spoilage models and performing RSL prediction, quality management system 200 cleans the logged or historical data obtained by quality measurement sensors like nose sensors. In one embodiment, a variety of preprocessing tools are used to preprocess and clean such data. Examples tools may include, without limitation, smoothing filtering, reconstruction of missing data, and de-noising operations to reduce amount of undesirable uncertainty in the data.

In one embodiment, feature extraction is performed as part of data pre-processing. Feature extraction increases the stability, reliability and convergence time of the models. Referring to FIG. 9, feature extraction is performed in each of the pipelines except fusion pipeline 1008. The role of feature extraction is to identify and feed spoilage parameter measurements data to the proposed learning algorithm that are indicative of the spoilage or damage. One characteristic of such features is that the feature be a surrogate for the damage and not depend on other input parameters.

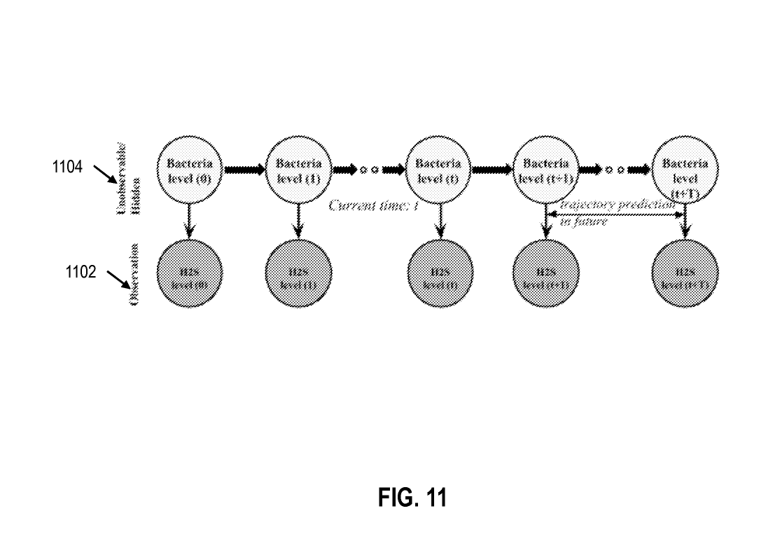

FIG. 11 illustrates an example representation of bacterial growth in time that is used for predicting an evaluation of food spoilage. Observable features 1102 may be extracted during data preprocessing. As an example, the observable features may include hydrogen sulfide measurements captured by sensors. The level of hydrogen sulfide is a signature of food deterioration and may be used to derive unobservable/hidden variables 1104. In the present example, this variable corresponds to a bacteria level of a food item. Based on the observed and unobserved variables, a trajectory may be computed and the bacteria level and hydrogen sulfide level of the food item may be computed for future time slices.

Tracking Food Spoilage and Deterioration

In one embodiment, quality management system 200 develops a Particle Filtering (PF) and Sequential Monte Carlo (SMC) approach to perform online estimations for spoilage state given the real-time measurements and ambient observation. Particle filter employs both chemical dynamic and various external food quality measurements (hydrogen sulfide production levels) to predict the evolution of the spoilage and the effects on food edibility quality.

Using PF and SMC, quality management system 200 can predict the time that food crosses a freshness threshold and is no longer consumable. As an example, let xₜ denote the spoilage measurement at time t (e.g. bacteria growth after 3 days of travel). Quality management system 200 considers spoilage chemical mechanisms to satisfy the monotonicity property and the Markov property (dependent on prior state) and model its evolution by Eq. 3 below:

xₜ₊₁=f(xₜ, ωₜ) Eq. 3

where ωₜis modeling noise and f(·)is the spoilage evolution model that represents how the spoilage evolves by time. For example bacteria growth may be modeled as follows:

$$log ( \frac{{x}_{t + 1}}{{x}_{t}} ) = - \frac{1}{D} t \qquad Eq . 4$$

where 1/D is the environmental dependent parameter. In the context of meat spoilage, D has relationship with temperature in the following way:

log(D)=−1/Z T+log(D₀) Eq. 5

where D₀ is a constant and depend on type of meat and T represents the temperature.

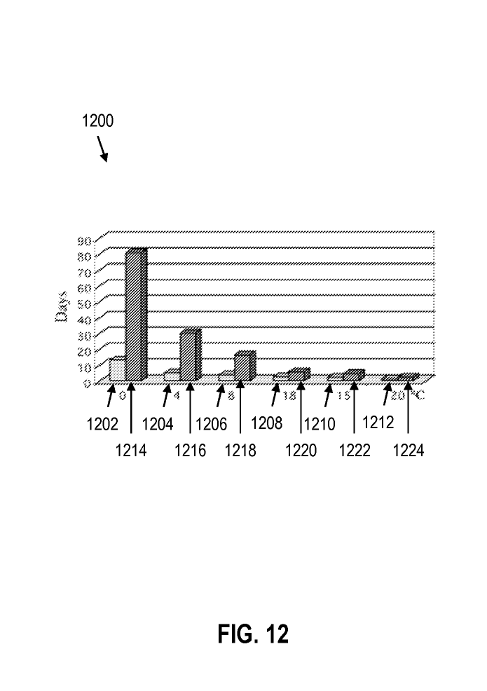

FIG. 12 illustrates bar chart 1200 depicting deterioration times for a perishable item stored at varying conditions. More specifically, bar chart 1200 depicts the duration of time before 10 million cells per square centimeter on pork meat is reached at different temperatures. Bars 1202, 1204, 1206, 1208, 1210, and 1212 correspond to measurements for pork meat stored in carbon dioxide, and bars 1214, 1216, 1218, 1220, 1222, and 1224 correspond to measurements for pork meat stored in air.

In some cases, the spoilage state (e.g. bacteria growth) is unable to be measured online. In such cases, sensor measurements that are affected by spoilage state are used to track food spoilage and deterioration. The spoilage state may be modeled by relationship between the state of the damage and the observation from system sensors by function g(·):

zₜ=g(xₜ, vₜ) Eq. 6

where zₜ is the measurement (also referred to as condition indicator) at time t which is affected by the existing damage process. Examples of condition indicators for spoilage are Hydrogen sulfide (H₂S) and Hydrogen peroxide (H₂O₂) emission, appearance and color change, and textural disorder. In Eq. 6 function g(·) represents the effect of spoilage and food decomposition on measurement z and vₜ is the measurement noise. In case of using nose sensors and imaging sensor for yeast, mold, odor inspection, the relation between bacteria growth xₜand observation zₜ at time t is zₜ=β₀+β₁xₜ+vₜ where β₀ and β₁ depends on the type of the meat and the temperature.

The PF approach recursively tracks and estimates a degree of belief in the spoilage state that is consistent with the observations made so far. In other words, the PF approach estimates the conditional probability of spoilage state at time k, xₖ, given all the condition indicator values up to time k, z_{0:k}; i.e. p(xₖ|z_{0:k}). In principle, PF uses Bayesian inference in nonlinear non-Gaussian dynamic model by exploiting some samples (also known as particles) with a set of corresponding weights to represent the conditional state probability.

RSL Prediction

In one embodiment, the fusion and RSL prediction stage generates approximations of food spoilage trajectory for L time in the future. In other words, at time k quality management system 200 calculates the spoilage state [or equivalently the freshness state and food quality] conditional probability given the observations up to current moment and the current ambient conditions. This is quantified by the following conditional probability:

p(x_{k+L}|z_{0:k}, θ_{k+L}) Eq. 7

where xᵢ is the spoilage state at time i, zⱼ is the signature measurement at time j [e.g. level of H2S], and θᵢ is the ambient condition at time i. With reference to Eq. 7, no information is available for estimating the likelihoods of the deterioration state following the future paths since future observations z_{k+1:k+L} have not yet been collected.

Using the evolution model in Eq. 3 and the estimated measurement, leads one to make prediction about future spoilage stage. Then using the spoilage state prediction, x_{k+1:k+L}, one can use Eq. 4 to predict the system condition indicators, i.e. z_{k+1:k+L}. The time T at which the estimated food condition indicator [e.g. unpleasant odor] cross the hazard threshold is mark as the food end of edibility (EOE) time. T-k is counted as remaining shelf life of the system. For example, using the collected ambient temperature and H2S emission from the food package in the past three weeks, quality management system 200 may first estimate the bacteria growth in next two weeks using Eq. 4. Then, having the bacterial growth rate and current environmental condition, quality management system 200 may estimate food deterioration in the next two weeks. Next, quality management system 200 may find a time at which the food quality is not high enough for end user consumption.

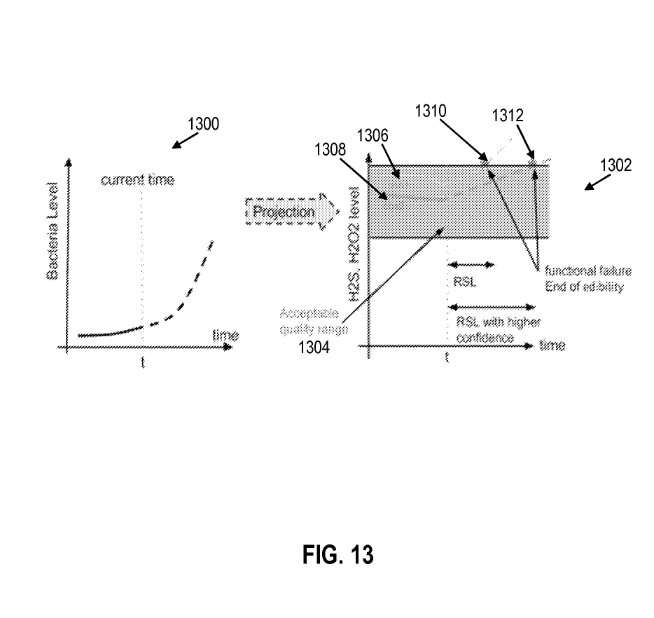

FIG. 13 illustrates a chart projecting remaining shelf life for a perishable item that is computed according to the above equations. Chart 1300 depicts time versus bacteria level with the current time represented by t. Left of time t represents observed or historical bacteria levels at prior points in time and right of time t represents predicted bacteria levels at future points in time.

Chart 1302 depicts the current time versus H2S and H2O2 levels. Area 1304 corresponds to an acceptable quality range. Plot 1306 represents the H2S levels and plot 1308 represents the H202 levels. Observed H2S and H202 levels are plotted to the left of current time t, and projected values are plotted to the right. Points 1310 and 1312 correspond to projections of plot 1306 and 1308 crossing threshold values and leaving area 1304. These points further correspond to the projected end of edibility/freshness for the perishable item.

Learning Physics-of-Failure Model

As explained before, quality management system 200 may use functions f(·)and g(·), to track spoilage. The parameterized spoilage evolution model and measurement models described above may be relevant to the different deterioration mechanisms including without limitation:
Bacterial growth evolution model for food deterioration represented as

$$log ( \frac{{x}_{t + 1}}{{x}_{t}} ) = - \frac{1}{D} t$$

Spoilage dependency on environmental temperature represented as

$$log ( D ) = - \frac{1}{Z} T + log ( {D}_{0} ) ;$$

and/or
Hydrogen sulfide emission due to meat spoilage represented as zₜ=β₀+β₁xₜ+vₜ

For complex systems these model may not be readily available. In such cases, a data-driven approach may be used to construct an estimation of evolution model and measurement model based on a training set. The training set could come from simulation, historical system inspection, or lab testing.

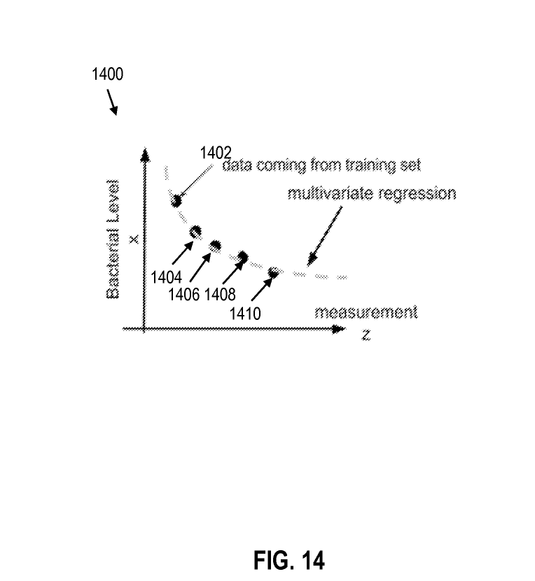

The training set is in the form of {xₜ, zₜ, θₜ} where it simply relates spoilage state to the observations [e.g. gas emission] and the environmental state [e.g. temperature]. Relevance vector machine (RVM) may be combined with multivariate regression methods based on library of functions to construct and update damage models, f(·), observation models, g(·). FIG. 14 is a chart depicting a multivariate regression approach for data-driven model generation. Chart 1400 plots measured values versus bacteria levels. Measured values include data points 1402, 1404, 1406, 1408, and 1410, which are received as part of a training set. Multivariate regression analysis is performed to compute a model based on the relationships among measured condition variables.

Emission Model Analysis and Validation

The modeling and analysis of available shipment data may be used towards the assessment of emissions from vehicle-provided real-time measurements on distance traveled, speed, and derived data on vehicle idling time. Such data may be applied to learn location and context sensitive idling and other driving parameters. This information may be exploited using existing physical models and factors to compute estimates of fuel consumption, green-house gas emissions, and other criteria pollutants resulting from the predicted activity (e.g. idling) reported and derived from the historical shipment data.

In one embodiment, high resolution data on second-by-second vehicle speeds is applied to advanced power demand models such as the Comprehensive Modal Emission Model (CMEM). The outputs of CMEM may be used to generate profiles of emissions that are classified by routes and road type. These profiles may take into consideration events such as idling and congestion that have previously been encountered by vehicles along traveled routes. The profiles may be used to generate emissions factors that can in turn be applied to predict individual emission emissions (e.g., carbon dioxide, carbon monoxide, hydrocarbons, mono-nitrogen oxides, etc.) over routes options that shippers evaluate as part of their decision function.

Data-Driven Probabilistic Programming

In one embodiment, a virtual sensor network performs distributed and scalable condition monitoring and assessments. The virtual sensors may be distributed in-vehicle and/or in-cloud. A “virtual sensor” as used herein refers to a modular software component performing specialized signal transformations and inferences (assessments) based on a) internal probabilistic models and b) input data streams. A set of virtual sensors may be dynamically programmed by models produced by learning pipelines and wired together to form a directed acyclic graph of their data dependencies. The virtual sensors may be executed in a distributed and parallel environment.

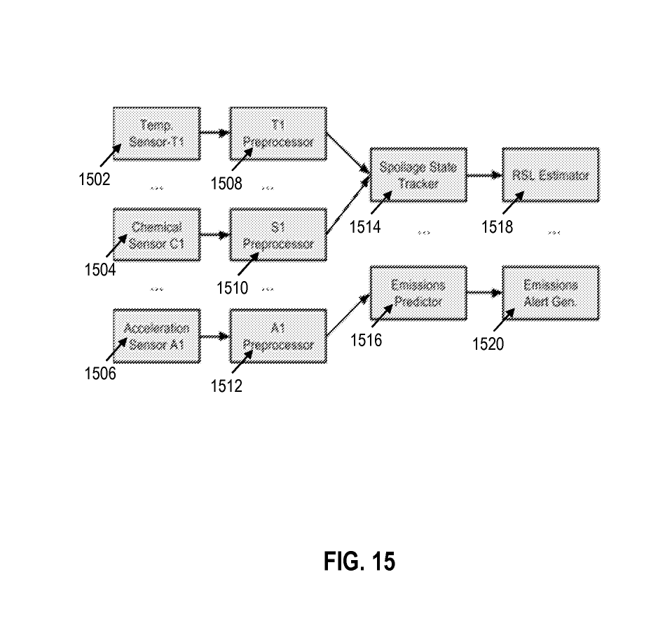

FIG. 15 illustrates a portion of the virtual sensor network, following the path of raw sensor data streams and how they are transformed for real-time predictions. The virtual sensor network is organized into layers so that data is processed and aggregated into increasingly higher levels of abstraction. The path of the raw data stream begins with physical sensors 1502, 1504, and 1506. The virtual sensors within the lowest physical sensor level are a collection of preprocessors that include virtual sensors 1508, 1510, and 1512. Example preprocessors at this level may include, without limitation, sensor failure reconstruction, noise reduction, normalization and/or feature extraction. Following the preprocessors, the data streams are fused by component that include virtual sensors 1514, 1516, 1518, and 1520. In the present example, virtual sensors 1514 is the component state tracker based on particle filter-based algorithms and virtual sensor 1516 is an RSL estimator. Virtual sensor 1518 is an emission predictor and virtual sensor 1520 is an emission alert generator.

Predictive Package Tracking

The techniques described herein may be used in to track package delivery and generate predictions on delivery quality. A “package” in this context refers to a mobile item that is transported by vehicle. Package tracking and prediction leverages sensors that are embedded or otherwise added to packages in a shipment. The sensors enable the shipper and/or the receiver to track delivery against expectations. For example, the sensors may generate data that indicates the current location of the package, what its health condition is, whether it is in a state of transition, etc. Quality management system 200 processes the sensor data to generate predictions and recommendations related to package delivery. For example, quality management system 200 may predict the ETA, RUL, and/or RSL of the packaged good.

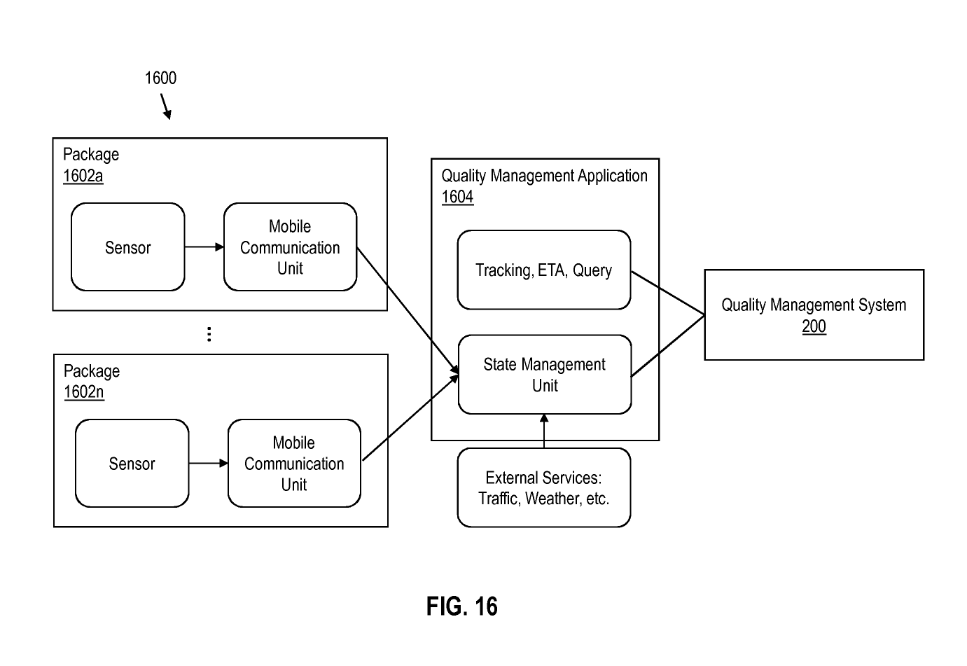

FIG. 16 illustrates an example system architecture for condition monitoring and prediction. System 1600 includes packages 1602a to 1602n representing a plurality of packages. Each of packages 1602a to 1602n includes one or more sensors (herein referred to as a “sensor subsystem”) and a mobile communication unit. The sensor subsystem periodically connects to a receiving logic within quality management application 1604. When connected, the sensor subsystem sends updated sensor state data. For example, the sensors may update the receiver as to the sensors current location, the condition of the package, and/or the condition of the transportation environment surrounding the package. The receiver translates the information into an approximate position and feeds the information along with other non-position sensor states to quality management system 200. This information is herein referred to as “package state information”. In addition to the package state information, the receiver may periodically transmit day/time-based average weather and traffic information about a transportation grid to quality management system 200.

Quality management system 200 fuses the package state data with transportation gird data and the previous routes taken for similar shipments. Quality management system 200 calculates the package condition and updates predictions about the condition. If anomalous conditions are likely, then quality management system 200 may communicate alerts to quality management application 1604.

Quality management application 1604 is further configured to receive and process queries related to the future state of a package. Example queries may include, without limitation, a request for an ETA of a package, an estimate of a future package condition, and/or an assessment of predicted vehicle emissions involved in package delivery. In response to receiving a query, quality management application 1604 obtains the predictions from quality management system 200 and presents the response to the user. The response may include, without limitation, a predicted result and information detailing the basis for arriving at the predicted result.

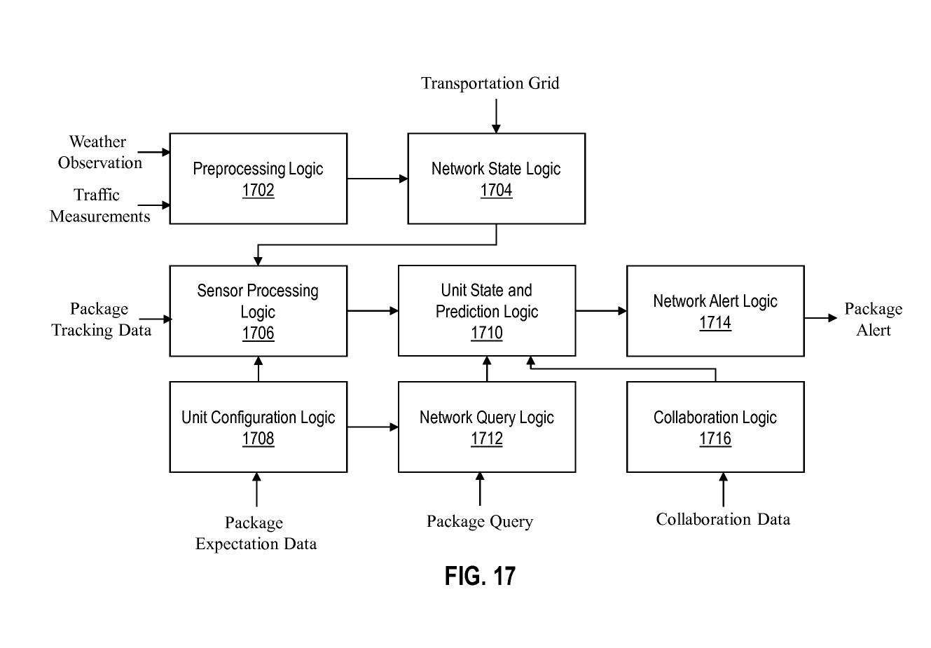

FIG. 17 illustrates an example dataflow for condition monitoring and prediction for packages, according to one embodiment. Preprocessing logic 1702 receives and preprocesses weather observation and traffic measurement data. The weather observation and traffic measurement data may be time-based averages of speeds and temperatures that observed in specific transportation grid cells. Preprocessing in this context may involve de-noising or otherwise cleaning the data and/or performing feature extraction.

Network state logic 1704 updates the state of a transportation grid based on data received from preprocessing logic 1702 and/or sensor processing logic 1706. Updating the network state may include, without limitation:
Updating current traffic, weather, and/or other conditions with one or more transportation cells in a transportation grid;
Building and updating probabilistic models; and/or
Adjusting the transportation cell size and/or other transportation cell attributes for cells within the transportation grid.

Sensor processing logic 1706 receives package tracking data for packages that are moving within the transportation grid. Package tracking data may include, without limitation, position data for the package, timestamp data, measured temperature, and/or other sensor data. Upon receipt, sensor processing logic 1706 may process the sensor and other package tracking data by performing feature extraction and other operations such as described above.

Unit configuration logic 1708 receives the processed sensor data for a unit and package expectation data for the unit. A “unit” in this context refers to a set of one or more packages that are part of a shipment. Package expectation data may include, without limitation:
A unique identifier for each package;
An end destination for the package;
A desired time of arrival for the package;
A maximum temperature allowed inside and/or outside the package;
A preferred set of waypoints along the route of the package for transmitting data;
A cooling capacity associated with the package; and/or
Information identifying which packages are shipped together.
   The package expectation data may be provided in advance of receiving any tracking data for a package. The package expectation data may be used to provide an initial calculation of time and weather risks associated with delivering the package.

Unit state and prediction logic 1710 maintains the current state of a unit and generates predictions for the unit. For example, units state and prediction logic 1710 may identify the current conditions of a unit based on the processed sensor data received from sensor processing logic 1706 and apply a probabilistic model based on the current state of the unit. Predictions may be generated for units that are in transit or units that have not yet shipped. In one embodiment, unit state and prediction logic 1710 may generate predictions for a hypothetical shipment that have no state information within the system. Generating predictions for hypothetical shipments allows a user to plan future shipments in advance based on the predictive models without any unit tracking data.

Network query logic 1712 receives and coordinates execution of package queries. The package query may include, without limitation, a request for:
An ETA of the package;
A likely location of the package at a specific point in the future;
A path that the package is likely to take;
A likely condition of the package at a specific point in the future; and/or
An estimated level of emissions.
   Network query logic 1712 coordinates with other logic units to provide a response to the query based on the current package state and the probabilistic models. Unit state and prediction logic 1710 may generate predictions in an on-demand basis based on queries received from network query logic 1712.

Network alert logic 1714 generates package alerts based on the current unit state and/or predicted unit state. Example package alerts may include, without limitation, data that identifies:
If the package is unusually stuck at a location;
If the package is likely to be exposed to an unacceptably high temperature at some point in the near future; and/or
If the package is unlikely to arrive on time.

Collaboration content logic 1716 performs operations relating to package collaboration. Collaboration content logic 1716 receives information from users regarding a package's state. This information may be useful if a package experiences anomalous conditions that are not picked up by the packing tracking data. The collaboration data may be sent to unit state and prediction logic 1710 to update unit state and prediction for a package.

Recommendation Generation and Responsive Actions

As previously indicated, actionable insight logic 206 may generate recommendations based on QoS predictions. The recommendations may generally comprise data that identifies actions that a user may take to improve a QoS. Example recommendations may include, without limitation:
Recommending an alternate route for a mobile item. Quality management system 200 may determine from the adaptive learning processes and probabilistic models an alternate route to improve ETA and recommend the route to the user.
Recommending corrective action for improvement of mobile item quality. Quality management system 200 may identify conditions that negatively impact the RUL or RSL of a package, and actionable insight logic 206 may recommend actions to correct or improve such conditions. As an example, actionable insight logic 206 may recommend reducing a shipping temperature in response to a prediction that it will rise above a required threshold value given current weather conditions.
Recommending price levels for a mobile item. Actionable insight logic 206 may recommend price levels based on the predicted freshness of a perishable item. If the item has a short RSL, a lower price may be recommended to move the item more quickly.

In another embodiment, actionable insight logic 206 may perform responsive actions based on QoS predictions. For example, if quality management system predicts the temperature will cross a threshold during shipment, actionable insight logic 206 may cause a refrigerated unit to automatically reduce its temperature. As another example, actionable insight logic 206 may cause the frequency with which sensors collect data to increase or decrease based on the current state of the network and/or conditions within a geographic region.

Cooperative and Adaptive Analytics

The cell-based transportation network representation and virtual sensor networks described above allow for route information sharing across multiple mobile items. In the context of a fleet of vehicles, for example, one vehicle may detect an abnormal cell event, such as an accident. This information is conveyed to quality management system 200, which may then recommend alternative routing to vehicles that share the same route or that are travelling routes that traverse the same cell.

Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

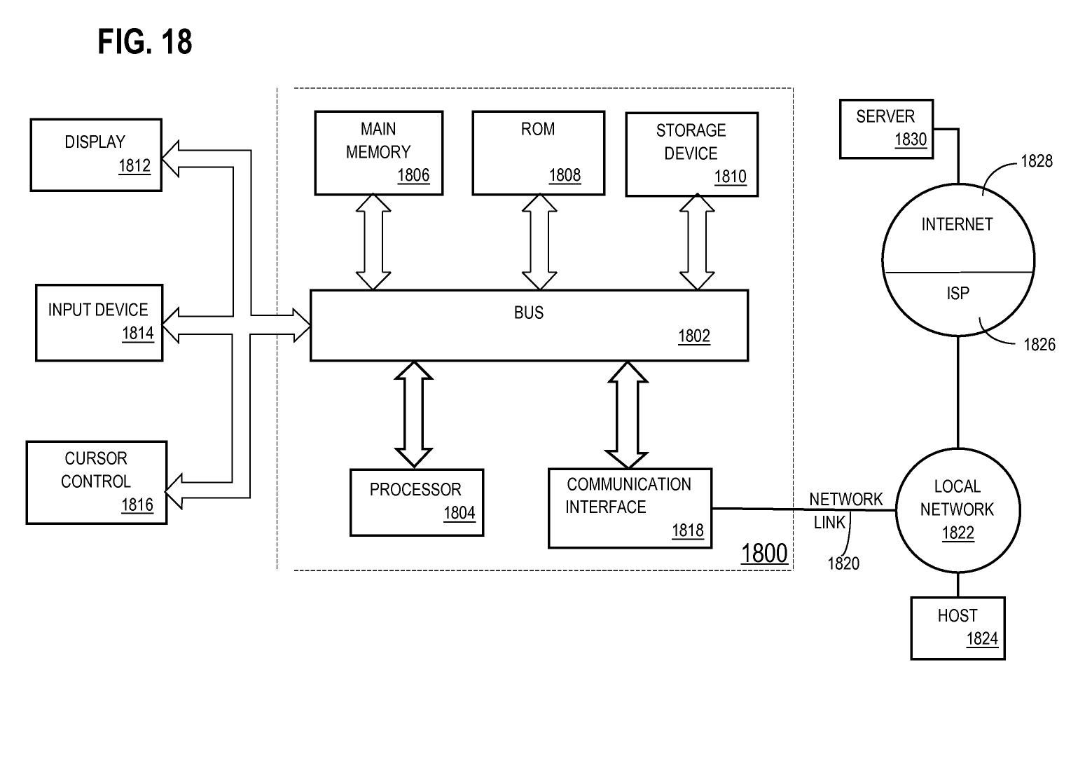

For example, FIG. 18 is a block diagram that illustrates a computer system 1800 upon which an embodiment of the invention may be implemented. Computer system 1800 includes a bus 1802 or other communication mechanism for communicating information, and a hardware processor 1804 coupled with bus 1802 for processing information. Hardware processor 1804 may be, for example, a general purpose microprocessor.

Computer system 1800 also includes a main memory 1806, such as a random access memory (RAM) or other dynamic storage device, coupled to bus 1802 for storing information and instructions to be executed by processor 1804. Main memory 1806 also may be used for storing temporary variables or other intermediate information during execution of instructions to be executed by processor 1804. Such instructions, when stored in non-transitory storage media accessible to processor 1804, render computer system 1800 into a special-purpose machine that is customized to perform the operations specified in the instructions.

Computer system 1800 further includes a read only memory (ROM) 1808 or other static storage device coupled to bus 1802 for storing static information and instructions for processor 1804. A storage device 1810, such as a magnetic disk, optical disk, or solid-state drive is provided and coupled to bus 1802 for storing information and instructions.

Computer system 1800 may be coupled via bus 1802 to a display 1812, such as a cathode ray tube (CRT), for displaying information to a computer user. An input device 1814, including alphanumeric and other keys, is coupled to bus 1802 for communicating information and command selections to processor 1804. Another type of user input device is cursor control 1816, such as a mouse, a trackball, or cursor direction keys for communicating direction information and command selections to processor 1804 and for controlling cursor movement on display 1812. This input device typically has two degrees of freedom in two axes, a first axis (e.g., x) and a second axis (e.g., y), that allows the device to specify positions in a plane.

Computer system 1800 may implement the techniques described herein using customized hard-wired logic, one or more ASICs or FPGAs, firmware and/or program logic which in combination with the computer system causes or programs computer system 1800 to be a special-purpose machine. According to one embodiment, the techniques herein are performed by computer system 1800 in response to processor 1804 executing one or more sequences of one or more instructions contained in main memory 1806. Such instructions may be read into main memory 1806 from another storage medium, such as storage device 1810. Execution of the sequences of instructions contained in main memory 1806 causes processor 1804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1810. Volatile media includes dynamic memory, such as main memory 1806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1802. Transmission media can also take the form of acoustic or light waves, such as those generated during radio-wave and infra-red data communications.

Various forms of media may be involved in carrying one or more sequences of one or more instructions to processor 1804 for execution. For example, the instructions may initially be carried on a magnetic disk or solid-state drive of a remote computer. The remote computer can load the instructions into its dynamic memory and send the instructions over a telephone line using a modem. A modem local to computer system 1800 can receive the data on the telephone line and use an infra-red transmitter to convert the data to an infra-red signal. An infra-red detector can receive the data carried in the infra-red signal and appropriate circuitry can place the data on bus 1802. Bus 1802 carries the data to main memory 1806, from which processor 1804 retrieves and executes the instructions. The instructions received by main memory 1806 may optionally be stored on storage device 1810 either before or after execution by processor 1804.

Computer system 1800 also includes a communication interface 1818 coupled to bus 1802. Communication interface 1818 provides a two-way data communication coupling to a network link 1820 that is connected to a local network 1822. For example, communication interface 1818 may be an integrated services digital network (ISDN) card, cable modem, satellite modem, or a modem to provide a data communication connection to a corresponding type of telephone line. As another example, communication interface 1818 may be a local area network (LAN) card to provide a data communication connection to a compatible LAN. Wireless links may also be implemented. In any such implementation, communication interface 1818 sends and receives electrical, electromagnetic or optical signals that carry digital data streams representing various types of information.

Network link 1820 typically provides data communication through one or more networks to other data devices. For example, network link 1820 may provide a connection through local network 1822 to a host computer 1824 or to data equipment operated by an Internet Service Provider (ISP) 1826. ISP 1826 in turn provides data communication services through the world wide packet data communication network now commonly referred to as the “Internet” 1828. Local network 1822 and Internet 1828 both use electrical, electromagnetic or optical signals that carry digital data streams. The signals through the various networks and the signals on network link 1820 and through communication interface 1818, which carry the digital data to and from computer system 1800, are example forms of transmission media.

Computer system 1800 can send messages and receive data, including program code, through the network(s), network link 1820 and communication interface 1818. In the Internet example, a server 1830 might transmit a requested code for an application program through Internet 1828, ISP 1826, local network 1822 and communication interface 1818.

The received code may be executed by processor 1804 as it is received, and/or stored in storage device 1810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, at one or more computing devices over a network from a set of electronic digital sensors that are affixed to mobile items, a set of sensor data that identifies a condition associated with at least one mobile item as the at least one mobile item moves through a particular geographic region that correspond to a particular cell in a transportation network representation of a route;
determining, by the one or more computing devices from the set of sensor data that identifies the condition associated with at least one mobile item, a correlation between the condition associated with the at least one mobile item and a set of one or more other conditions that are associated with the particular cell;
based, at least in part, on the correlation between the condition associated with the at least one mobile item and the set of one or more other conditions that are associated with the particular cell, generating, by the one or more computing devices, a prediction of a quality of service for a particular item that is associated with the route including the particular geographic region corresponding to the particular cell in the transportation network representation.

2. The method of claim 1, wherein determining, by the one or more computing devices from the set of sensor data that identifies the condition associated with the at least one mobile item, the correlation between the condition associated with the at least one mobile item and the set of one or more other conditions that are associated with the particular cell comprises learning a causal relationship between the set of one or more conditions and the condition associated with the at least one mobile item.

3. The method of claim 1, further comprising building a pattern-aware probabilistic model based, at least in part, on the correlation between the condition associated with the at least one mobile item and a set of one or more other conditions that are associated with the particular cell.

4. The method of claim 1, further comprising storing a Bayesian model for the cell;
wherein the Bayesian model connects the set of one or more conditions that are associated with the particular cell to the condition associated with the at least one mobile item.

5. The method of claim 1, wherein the geographical region corresponding to the particular cell is a bounded rectangular area.

6. The method of claim 1, further comprising adjusting a size of a plurality of cells in the transportation network representation based, at least in part, on a sampling rate associated with collecting data from the set of sensors.

7. The method of claim 1, wherein the condition associated with the at least one mobile item is one of a duration that the at least one mobile item remains in the particular cell or a spoilage trajectory for the at least one mobile item; wherein the set of one or more conditions that are associated with the particular cell include one or more of weather observations or traffic conditions.

8. The method of claim 1, wherein the prediction of the quality of service includes a prediction for one or more of an estimated time of arrival for the particular item, a remaining useful life for the particular item, a remaining shelf life for the particular transported perishable item or a predicted level of emissions of the vehicle involved in delivering the particular item.

9. The method of claim 1 further comprising generating, by the one or more computing devices, recommendation data that includes a recommendation for improving the predicted quality of service; and causing display of the recommendation data.

10. The method of claim 1, further comprising detecting an abnormal cell event for the particular cell; in response to detecting the abnormal cell event, sending a recommendation to a vehicle in a different cell to change a delivery route.

11. One or more non-transitory computer-readable media storing instructions which, when executed, cause performance of:
receiving, at one or more computing devices over a network from a set of electronic digital sensors that are affixed to mobile items, a set of sensor data that identifies a condition associated with at least one mobile item as the at least one mobile item moves through a particular geographic region that correspond to a particular cell in a transportation network representation of a route;
determining, by the one or more computing devices from the set of sensor data that identifies the condition associated with at least one mobile item, a correlation between the condition associated with the at least one mobile item and a set of one or more other conditions that are associated with the particular cell;
based, at least in part, on the correlation between the condition associated with the at least one mobile item and the set of one or more other conditions that are associated with the particular cell, generating, by the one or more computing devices, a prediction of a quality of service for a particular item that is associated with the route including the particular geographic region corresponding to the particular cell in the transportation network representation.

12. The one or more non-transitory computer-readable media of claim 11, wherein instructions for determining, by the one or more computing devices from the set of sensor data that identifies the condition associated with the at least one mobile item, the correlation between the condition associated with the at least one mobile item and the set of one or more other conditions that are associated with the particular cell comprise instructions for learning a causal relationship between the set of one or more conditions and the condition associated with the at least one mobile item.

13. The one or more non-transitory computer-readable media of claim 11, further comprising instructions which when executed cause performing: building a pattern-aware probabilistic model based, at least in part, on the correlation between the condition associated with the at least one mobile item and a set of one or more other conditions that are associated with the particular cell.

14. The one or more non-transitory computer-readable media of claim 11, further comprising instructions which when executed cause performing: storing a Bayesian model for the cell; wherein the Bayesian model connects the set of one or more conditions that are associated with the particular cell to the condition associated with the at least one mobile item.

15. The one or more non-transitory computer-readable media of claim 11, wherein the geographical region corresponding to the particular cell is a bounded rectangular area.

16. The one or more non-transitory computer-readable media of claim 11, further comprising instructions which when executed cause performing: adjusting a size of a plurality of cells in the transportation network representation based, at least in part, on a sampling rate associated with collecting data from the set of sensors.

17. The one or more non-transitory computer-readable media of claim 11, wherein the condition associated with the at least one mobile item is one of a duration that the at least one mobile item remains in the particular cell or a spoilage trajectory for the at least one mobile item; wherein the set of one or more conditions that are associated with the particular cell include one or more of weather observations or traffic conditions.

18. The one or more non-transitory computer-readable media of claim 11, wherein the prediction of the quality of service includes a prediction for one or more of an estimated time of arrival for the particular item, a remaining useful life for the particular item, a remaining shelf life for the particular item or a predicted level of emissions involved in delivering the particular item.

19. The one or more non-transitory computer-readable media of claim 11, further comprising instructions which when executed cause performing: generating, by the one or more computing devices, recommendation data that includes a recommendation for improving the predicted quality of service; and causing display of the recommendation data.

20. The one or more non-transitory computer-readable media of claim 11, further comprising instructions which when executed cause performing: detecting an abnormal cell event for the particular cell; in response to detecting the abnormal cell event, sending a recommendation to a vehicle in a different cell to change a delivery route.
